(19) United States
(12) Patent Application Publication
(10) Pub. No.: US 2007/0033570 A1
(43) Pub. Date: Feb. 8, 2007

(54) Method and system for transforming a process flow

(76) Inventor: Raymond Lee-Man Kong, Markham (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/195,461

(22) Filed: Aug. 2, 2005

(51) Int. Cl. G06F 9/44

(52) U.S. Cl. 717/104

(57) ABSTRACT

The invention provides a solution for generating a target process flow based on a source process flow of a different model format. In particular, for each element in the source process flow that maps to multiple elements in the target process flow, a container element is created in the target process flow to abstract the multiple elements, which are included in the container element. In this manner, visual consistency is maintained between the source process flow and target process flow, while also maintaining the semantics of the source process flow in the target process flow.

### BACKGROUND OF THE INVENTION

1. Technical Field

The invention relates generally to transforming a process flow, and more particularly, to a solution for generating a second process flow in a different model format than a first process flow.

2. Background Art

Process modeling is frequently used to generate complex systems. A process flow describes and captures the logic and specification of how the process is to be implemented. Currently, there are several well-known process modeling tools in the market, including Rational Process Workbench® and WebSphere® Business Integration Modeler both offered by International Business Machines Corp. of Armonk, N.Y. Many process modeling tools include features that are beneficial to a particular group of users (e.g., software developers, integration planners, etc.). As a result, users often prefer to use a particular process modeling tool that is configured to their requirements.

The process modeling tools use various model formats, examples of which include Business Process Execution Language for web services (BPEL), Unified Modeling Language (UML), process-definition language (FDL), and WebSphere Business Integration Modeler model, etc., for managing (e.g., storing, retrieving, etc.) the data for the process flows that each process modeling tool manages. Each model format includes its own specification, terminology, notation, and methodology with which the process flow is defined and stored. However, a project may require the input of different groups of users as the project progresses from one stage (e.g., planning) to the next (e.g., implementation), and each group of users may be using a different process modeling tool. Consequently, it is frequently desirable to share a process flow between two or more of the process modeling tools. As a result, process modeling tools typically include the ability to transform (e.g., import or export) a process flow from one model format to another model format.

Frequently, an element in one model format does not map to a single element in a target model format. To this extent, one problem with the current solutions for transforming process flows is their inability to maintain a balance between capturing the original semantics and/or logic of the source process flow while maintaining the visual traceability between the source process flow and the target process flow. In particular, when too few elements are included in the process flow in the target model format, the target process flow may capture the original visual appearance, but lose the semantics. Conversely, when all the mapped elements are included in the process flow in the target model format, the original semantics may be captured, but the visual appearance will be lost. In either case, a user will likely be confused by the difference between the process flows. As a result, the usability of the target process flow is reduced.

To this extent, a need exists for an improved solution for transforming a process flow from one model format to another model format.

### SUMMARY OF THE INVENTION

The invention provides a solution for transforming a process flow. In particular, a target process flow in one model format is generated based on a source process flow in a different model format. To this extent, for each element in the source process flow that maps to multiple elements in the target process flow, a container element is created in the target process flow to abstract the multiple elements, which are included in the container element. The transformation can be performed as part of an import request and/or export request generated by a user of a process modeling tool and/or in response to a request received from one or more external systems. In any event, the invention enables visual consistency to be maintained between the source process flow and target process flow, while also maintaining the semantics of the source process flow in the target process flow.

A first aspect of an embodiment of the invention provides a method of transforming a process flow, the method comprising: obtaining a source process flow in a first model format, wherein the source process flow includes a set of source elements; and generating a target process flow in a second model format based on the source process flow, wherein the generating step includes, for each source element in the set of source elements that maps to a plurality of target elements in the second model format: applying a semantics mapping of the source element to the plurality of target elements; abstracting the plurality of target elements in a container element; and adding the container element with the plurality of target elements to the target process flow.

A second aspect of an embodiment of the invention provides a system for transforming a process flow, the system comprising: a system for obtaining a source process flow in a first model format, wherein the source process flow includes a set of source elements; and a system for generating a target process flow in a second model format based on the source process flow, wherein the system for generating includes a system for processing each source element in the set of source elements that maps to a plurality of target elements in the second model format that includes: a system for applying a semantics mapping of the source element to the plurality of target elements; a system for abstracting the plurality of target elements in a container element; and a system for adding the container element with the plurality of target elements to the target process flow.

A third aspect of an embodiment of the invention provides a process modeling tool that includes: a system for managing an editor that enables a user to manage process flows; a system for receiving a transform request for a source process flow in a first model format, wherein the source process flow includes a set of source elements; and a system for generating a target process flow in a second model format based on the source process flow, wherein the system for generating includes a system for processing each source element in the set of source elements that maps to a plurality of target elements in the second model format that includes: a system for applying a semantics mapping of the source element to the plurality of target elements; a system for abstracting the plurality of target elements in a container element; and a system for adding the container element with the plurality of target elements to the target process flow.

A fourth aspect of an embodiment of the invention provides a program product stored on a computer-readable medium, which when executed, transforms a process flow, the program product comprising: program code for obtaining a source process flow in a first model format, wherein the source process flow includes a set of source elements; and program code for generating a target process flow in a second model format based on the source process flow, wherein the program code for generating includes program code for processing each source element in the set of source elements that maps to a plurality of target elements in the second model format that includes: program code for applying a semantics mapping of the source element to the plurality of target elements; program code for abstracting the plurality of target elements in a container element; and program code for adding the container element with the plurality of target elements to the target process flow.

A fifth aspect of an embodiment of the invention provides a computer-readable medium that includes computer program code to enable a computer infrastructure to transform a process flow, the computer-readable medium comprising computer program code for performing the method steps of an embodiment of the invention.

A sixth aspect of an embodiment of the invention provides a method of offering a service to a customer of transforming a process flow, the method comprising managing a computer infrastructure adapted to perform each of the steps of an embodiment of the invention; and receiving payment based on the managing step.

A seventh aspect of an embodiment of the invention provides a method of generating a system for transforming a process flow, the method comprising: obtaining a computer infrastructure; and deploying means for performing each of the steps of an embodiment of the invention to the computer infrastructure.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for transforming a process flow according to one embodiment of the invention;

FIG. 2 shows illustrative steps for transforming the process flow according to another embodiment of the invention;

FIG. 3 shows an illustrative transformation of an FDL process flow to a WebSphere Business Integration Modeler (WBIM) process flow; and

FIG. 4 shows an illustrative set of elements for the container element of FIG. 3.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for transforming a process flow. In particular, a target process flow in one model format is generated based on a source process flow in a different model format. To this extent, for each element in the source process flow that maps to multiple elements in the target process flow, a container element is created in the target process flow to abstract the multiple elements, which are included in the container element. The transformation can be performed as part of an import request and/or export request generated by a user of a process modeling tool and/or in response to a request received from one or more external systems. In any event, the invention enables visual consistency to be maintained between the source process flow and target process flow, while also maintaining the semantics of the source process flow in the target process flow.

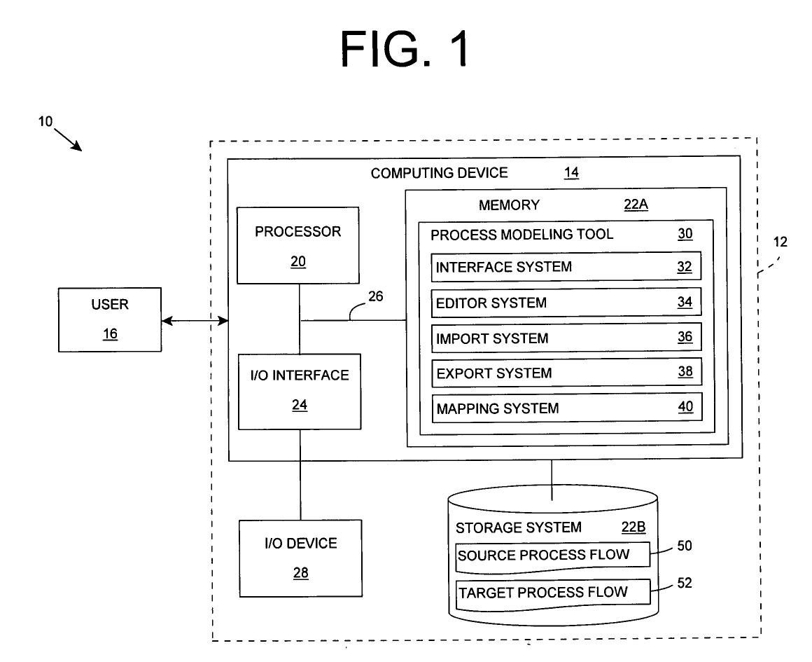

Turning to the drawings, FIG. 1 shows an illustrative system 10 for transforming a process flow. To this extent, system 10 includes a computer infrastructure 12 that can perform the various process steps described herein for transforming a process flow. In particular, computer infrastructure 12 is shown including a computing device 14 that comprises a process modeling tool 30, which enables computing device 14 to generate a target process flow 52 based on a source process flow 50 that is stored in a different model format, by performing the process steps of the invention.

Computing device 14 is shown including a processor 20, a memory 22A, an input/output (I/O) interface 24, and a bus 26. Further, computing device 14 is shown in communication with an external I/O device/resource 28 and a storage system 22B. As is known in the art, in general, processor 20 executes computer program code, such as process modeling tool 30, that is stored in memory 22A and/or storage system 22B. While executing computer program code, processor 20 can read and/or write data, such as source process flow 50, to/from memory 22A, storage system 22B, and/or I/O interface 24. Bus 26 provides a communications link between each of the components in computing device 14. I/O device 28 can comprise any device that enables user 16 to interact with computing device 14 or any device that enables computing device 14 to communicate with one or more other computing devices.

In any event, computing device 14 can comprise any general purpose computing article of manufacture capable of executing computer program code installed by a user 16 (e.g., a personal computer, server, handheld device, etc.). However, it is understood that computing device 14 and process modeling tool 30 are only representative of various possible equivalent computing devices that may perform the various process steps of the invention. To this extent, in other embodiments, computing device 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As previously mentioned and discussed further below, process modeling tool 30 enables computing infrastructure 12 to transform a process flow. To this extent, process modeling tool 30 is shown including an interface system 32 for managing an interface that enables user 16 to use process modeling tool 30, an editor system 34 that enables user 16 to create, modify, delete, etc., source and/or target process flows 50, 52, an import system 36 that enables user 16 to define a process flow to be imported, an export system 38 that enables user 16 to define parameters for exporting a process flow, and a mapping system 40 that transforms source process flow 50 to target process flow 52. Operation of each of these systems is discussed further below. However, it is understood that some of the various systems shown in FIG. 1 can be implemented independently, combined, and/or stored in memory for one or more separate computing devices that are included in computer infrastructure 12. To this extent, mapping system 40 could comprise a “plug-in” or the like that is implemented independently of process modeling tool 30 and can interface with multiple types of process modeling tools 30. Further, it is understood that some of the systems and/or functionality may not be implemented, or additional systems and/or functionality may be included as part of system 10.

In general, process modeling tool 30 will support a subset of all possible model formats for defining and storing source and/or target process flows 50, 52. To this extent, this invention provides a solution for transforming a process flow 50, 52 from one model format to another model format. Typically, this functionality is accessed within process modeling tool 30 in one of two manners. First, user 16 can select to “import” a process flow, which includes transforming a source process flow 50 in a model format that is not supported by process modeling tool 30 into a target process flow 52 in a model format that is supported by process modeling tool 30. Second, user 16 can select to “export” a process flow, which includes transforming a source process flow 50 from a model format that is supported by process modeling tool 30 into a target process flow 52 in a model format that is not supported by process modeling tool 30. To this extent, process modeling tool 30 can support the display and/or modification of source process flows 50 (during an export request) and/or target process flows 52 (during an import request) that are defined in the subset of supported model formats.

In any event, process modeling tool 30 enables user 16 to manage source and/or target process flows 50, 52. To this extent, interface system 32 can manage a user interface that enables user 16 to manage source process flow 50 and/or target process flow 52. In particular, user 16 can use one or more user interface controls included in the user interface to select various operations to be performed by process modeling tool 30 on source process flow 50 and/or target process flow 52. For example, user 16 can select to generate, display, and/or modify source and/or target process flows 50, 52.

In response to this selection, interface system 32 can display an editor within the interface. To this extent, process modeling tool 30 is shown including an editor system 34 that manages one or more editors that enable user 16 to view and/or modify source and/or target process flows 50, 52. In general, editor system 34 will generate an editor for display by interface system 32, which enables user 16 to view and/or modify process flows, such as source process flow 50 in a particular model format, such as Business Process Execution Language for web services (BPEL), Unified Modeling Language (UML), process-definition language (FDL), or the like. To this extent, editor system 34 will typically store and access the process flow using a storage object. The storage object can comprise one or more files in a file system, records in a database, memory objects, or the like, that include data for the process flow based on the definition of the corresponding model format. As is known, each storage object can comprise an identification of the format of the data stored therein. For example, a file that comprises data for a process flow of a particular model format can include a designated file extension and/or data that identifies the model format and/or version used to store the data therein. As a result, the model format for a process flow can be determined based on the storage object that stores the data for the process flow.

As noted above, the various process modeling tools 30 manage process flows defined in multiple model formats. To this extent, process modeling tool 30 is shown including an import system 36 that enables user 16 to generate an import request to transform a process flow, such as source process flow 50, from a model format that is not supported by editor system 34 to a model format that is supported by editor system 34. In particular, import system 36 can manage a user interface that enables user 16 to identify a storage object that stores the data for source process flow 50, and allows user 16 to request that source process flow 50 be transformed into a target process flow 52 having a model format supported by editor system 34. Further, import system 36 can enable user 16 to designate a storage object for target process flow 52. In any event, import system 36 can determine the model format of source process flow 50 based on the storage object. If the storage object appears to include a source process flow 50 in a model format that can be transformed, import system 36 can forward data on the import request to mapping system 40 for processing.

Similarly, process modeling tool 30 is shown including an export system 38 that enables user 16 to generate an export request to transform a process flow, such as source process flow 50, from a model format that is supported by editor system 34 to a model format that is supported by another process modeling tool. In particular, export system 38 can manage a user interface that enables user 16 to identify source process flow 50 (e.g., by the storage object) and identify a target model format for target process flow 52. Alternatively, user 16 can identify a target process modeling tool for which the transformation is desired and export system 38 can determine a model format for target process flow 52 based on the target process modeling tool. Further, export system 38 can enable user 16 to designate a storage object for target process flow 52. In any event, export system 38 can include the target model format and storage object in the export request, and can forward data on the export request to mapping system 40 for processing.

Alternatively, interface system 32 can support communications between process modeling tool 30 and one or more other systems/program products. In this case, another system/program product can communicate an import/export request for source process flow 50 to process modeling tool 30 using any type of communications solution, such as an application program interface (API), a communications protocol, or the like. In any event, interface system 32 will receive the import/export request and can forward it to the corresponding system for processing. In particular, if the request comprises an import request, it can be forwarded to import system 36, which can determine the model format of the source process flow 50 identified in the import request and/or can confirm other data included in the import request. Similarly, if the request comprises an export request, it can be forwarded to export system 36, which can determine the model format of target process flow 52 based on the export request and/or can confirm other data included in the export request. If import system 36 or export system 38 determines that the import/export request can be processed by mapping system 40, import system 36 or export system 38 can forward the import/export request for processing by mapping system 40.

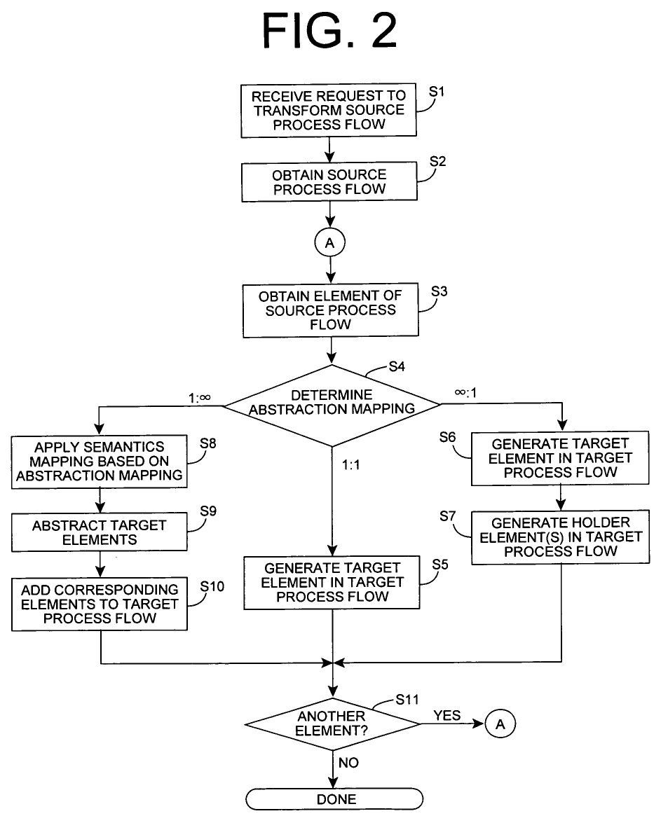

Regardless, the invention provides a system and method for transforming a process flow. To this extent, FIG. 2 shows illustrative steps that can be implemented by the mapping system 40 of FIG. 1 to transform the process flow. Referring to FIGS. 1 and 2, in step S1 of FIG. 2, mapping system 40 can receive a request to transform source process flow 50. As noted above, an import/export request may be generated by user 16 and/or received by interface system 32 from another system/program product. In either case, import system 36 or export system 38 can generate a transform request based on the import/export request and can provide the transform request to mapping system 40.

In any event, in step S2, mapping system 40 obtains source process flow 50 based on the transform request. In general, the transform request will identify a storage object that comprises source process flow 50, and mapping system 40 can obtain source process flow 50 from the identified storage object. Alternatively, the transform request can comprise source process flow 50 and mapping system 40 can extract the source process flow 50 from the data in the transform request.

Once source process flow 50 has been obtained, mapping system 40 can transform source process flow 50. In particular, mapping system 40 can generate target process flow 52 in a second model format based on source process flow 50 in a first model format. As is known, process flows 50, 52 will each include a set (one or more) of elements and a related set (zero or more) of connectors. In general, an element in process flow 50, 52 can be connected to one or more elements via a particular connector. To this extent, the various element(s) and/or connectors visually define the process flow 50, 52 for user 16. In any event, in step S3, mapping system 40 can obtain an element of source process flow 50 for transformation. Mapping system 40 can select the element using any known solution. For example, mapping system 40 can select a first element in source process flow 50 (source element) and sequentially select subsequent source element(s) based on the connectors. When connectors indicate that a source element branches to two or more elements, mapping system 40 can completely traverse the source elements of one branch, and subsequently traverse the source elements of the other branch(es).

As noted previously, the various model formats are developed and/or defined with a particular set of target users 16 in mind. As a result, a source element in one model format may not have a corresponding single element in a second model format. To this extent, in step S4, mapping system can determine an abstraction mapping of the source element to one or more elements in the second model format.

It is understood that mapping system 40 can determine the abstraction mapping using any known solution. For example, mapping system 40 can manage a set (one or more) of abstraction mapping patterns for each possible mapping between two model formats. Each abstraction mapping pattern in each set of abstraction mapping patterns can define an abstraction mapping between a type of element in one model format to one or more elements in another model format. When the abstraction mapping between the corresponding two model formats is to be performed, mapping system 40 can select the appropriate set of abstraction mapping patterns. Subsequently, when mapping system 40 processes an element the abstraction mapping pattern that corresponds to the type of element 60 can be selected and used for the abstraction mapping.

Based on the determined abstraction mapping, mapping system 40 will process the source element in a different manner. For example, when a source element maps directly to a single element in the second model format (e.g., 1:1), then in step S5, mapping system 40 can generate the single element in target process flow 52 (target element). Alternatively, when multiple source elements map to a single target element (e.g., ∞:1), then in step S6, mapping system 40 can generate the single target element in target process flow 52 and in step S7, mapping system 40 can generate one or more additional holder element(s) in target process flow 52. In this case, the single target element can comprise the semantic information from the source elements and the same visual appearance of source process flow 50 can be maintained in target process flow 52 by including the same number of target elements as source elements. It is understood, however, that this is only illustrative, and mapping system 40 could just generate the single target element or use any other known solution to implement the many-to-one mapping.

Frequently, a source element in a first model format maps to multiple target elements in a second model format. In this case, in step S8, mapping system 40 can apply a semantics mapping based on the abstraction mapping. In particular, mapping system 40 can generate the multiple target elements based on the abstraction mapping. For example, a program element in the FDL model format can comprise a program activity having an exit condition that may cause re-execution of the program activity. In order to transform such an exit condition to another model format, such as the WebSphere Business Integration Modeler (WBIM) model format, while still preserving the semantic information, a do-while loop may need to be introduced together with other supporting elements. As a result, the FDL program element will map to multiple target WBIM elements. It is understood that various types of mappings for various source elements may be more complex. For example, a single element may map to multiple elements that include one or more branches.

In any event, when a source element maps to multiple target elements, the visual appearance of target process flow 52 can vary dramatically from the visual appearance of source process flow 50. This problem is compounded when multiple source elements each map to multiple target elements. As a result, in step S9, mapping system 40 can abstract the multiple target elements. In particular, in order to maintain a consistent visual appearance between source process flow 50 and target process flow 52 mapping system 40 can generate a container element that comprises an element in target process flow 52 that includes the multiple target elements to which the source element mapped. In step S10, mapping system 40 can add the corresponding elements (e.g., the container element with the multiple target elements included therein) to target process flow 52.

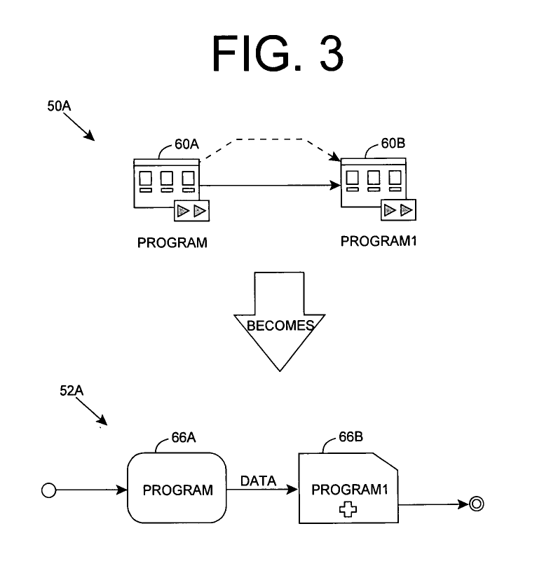

To this extent, FIG. 3 shows an illustrative transformation of an FDL process flow 50A to a WBIM process flow 52A. In particular, FDL process flow 50A is shown including a first program element 60A followed by a second program element 60B. In an illustrative embodiment, program element 60A can map to a single WBIM element, while program element 60B can map to multiple WBIM elements. To this extent, WBIM process flow 52A is shown including a program element 66A that maps (e.g., in a one-to-one manner) to the first program element 60A, and a container element 66B that provides an abstraction mapping to the second program element 60B, thereby maintaining a consistent visual appearance between FDL process flow 50A and WBIM process flow 52A.

Referring to FIGS. 1 and 3, when WBIM process flow 52A is displayed by, for example, interface system 32, user 16 can navigate process flow 52A to obtain the semantic information of the original FDL process flow 50A. In particular, user 16 can select to view the various elements included in a particular container element 66B. For example, user 16 can double-click on container element 66B to view the corresponding elements. In response, interface system 32 can display the elements that are included in container element 66B as a result of the mapping of program element 60B. Further, it is understood that a container element 66B can include one or more additional container elements 66B, thereby creating a hierarchy of abstractions.

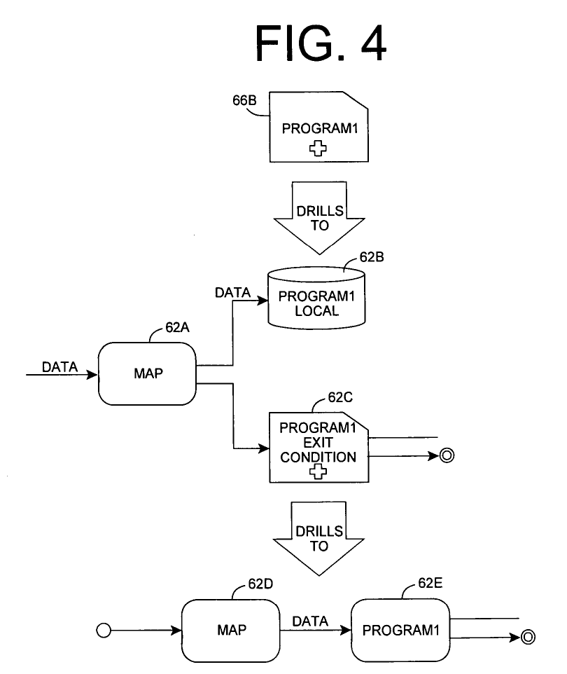

For example, FIG. 4 shows an illustrative set of elements 62A-C that can be included in container element 66B. Referring to FIGS. 1 and 4, when user 16 selects to view (e.g., drill down) the contents of container element 66B, interface system 32 can display elements 62A-C. In this case, element 62C can comprise a do-while loop that includes additional elements 62D-E therein. When the contents of element 62C are requested to be displayed, interface system 32 can display elements 62D-E. To this extent, container element 66B provides an abstraction of all elements 62A-E. Together, elements 62A-E include all the semantic information from the original source element 60B (FIG. 3), while container element 66B enables the WBIM process flow 52A (FIG. 3) to maintain a similar visual appearance as that included in FDL process flow 50A (FIG. 3). Consequently, the invention provides a solution for maintaining both the visual appearance and semantic information when transforming source process flow 50 into target process flow 52.

Returning to FIGS. 1 and 2, once a source element has been processed by mapping system 40, then in step S11, mapping system 40 can determine if another element requires processing. If so, then flow can return to step S3, otherwise the processing can complete. Mapping system 40 can repeat this process for each source element until the entire source process flow 50 has been transformed into target process flow 52. It is understood that the method steps shown are only illustrative. To this extent, additional steps can be included, steps can be performed in a different order, when possible, or the like. For example, mapping system 40 will further process each connector that is included in source process flow 50 in a known manner. The processing of each connector can be performed, for example, after the processing of an element has completed, but prior to step S11. This step has not been shown for clarity.

While shown and described herein as a method and system for transforming a process flow, it is understood that the invention further provides various alternative embodiments. For example, in one embodiment, the invention provides a computer-readable medium that includes computer program code to enable a computer infrastructure to transform a process flow. To this extent, the computer-readable medium includes program code, such as process modeling tool 30 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22A (FIG. 1) and/or storage system 22B (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a method that performs the process steps of the invention on a subscription, advertising, and/or fee basis. That is, a service provider, such as an Application Service Provider, could offer to transform a process flow as described herein. In this case, the service provider can create, maintain, support, etc., a computer infrastructure, such as computer infrastructure 12 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for transforming a process flow. In this case, a computer infrastructure, such as computer infrastructure 12 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 14 (FIG. 1), from a computer-readable medium; (2) adding one or more computing devices to the computer infrastructure; and/or (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like, and can be provided together with an installation program that installs the program product.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of transforming a process flow, the method comprising:
obtaining a source process flow in a first model format, wherein the source process flow includes a set of source elements; and
generating a target process flow in a second model format based on the source process flow, wherein the generating step includes, for each source element in the set of source elements that maps to a plurality of target elements in the second model format:
applying a semantics mapping of the source element to the plurality of target elements;
abstracting the plurality of target elements in a container element; and
adding the container element with the plurality of target elements to the target process flow.

2. The method of claim 1, wherein the obtaining step includes:
identifying a storage object that comprises the source process flow; and
determining the first model format based on the storage object.

3. The method of claim 1, wherein the obtaining step includes managing an editor that enables a user to manage the source process flow.

4. The method of claim 1, wherein the generating step further includes determining, for each source element, a mapping of the source element to at least one target element in the second model format.

5. The method of claim 1, wherein the generating step further includes, for a plurality of source elements in the set of source elements that map to a single target element in the target process flow:
generating the single target element in the target process flow; and
generating at least one holder element in the target process flow.

6. The method of claim 1, wherein the generating step further includes, for each source element in the set of source elements that maps to a single target element in the second model format, generating the single target element in the target process flow.

7. The method of claim 1, further comprising storing the target process flow in a storage object.

8. The method of claim 1, further comprising receiving a transform request for the source process flow.

9. The method of claim 1, further comprising:
receiving a target process modeling tool; and
determining the second model format based on the target process modeling tool.

10. A method of generating a system for transforming a process flow, the method comprising:
obtaining a computer infrastructure; and
for each of the steps of claim 1, deploying a means for performing the step to the computer infrastructure.

11. A computer-readable medium for enabling a computer infrastructure to transform a process flow, the computer-readable medium comprising computer program code for performing the method steps of claim 1.

12. A system for transforming a process flow, the system comprising:
a system for obtaining a source process flow in a first model format, wherein the source process flow includes a set of source elements; and
a system for generating a target process flow in a second model format based on the source process flow, wherein the system for generating includes a system for processing each source element in the set of source elements that maps to a plurality of target elements in the second model format that includes:
a system for applying a semantics mapping of the source element to the plurality of target elements;
a system for abstracting the plurality of target elements in a container element; and
a system for adding the container element with the plurality of target elements to the target process flow.

13. The system of claim 12, wherein the system for obtaining includes:
a system for identifying a storage object that comprises the source process flow; and
a system for determining the first model format based on the storage object.

14. The system of claim 12, wherein the system for obtaining includes a system for managing an editor that enables a user to manage the source process flow.

15. The system of claim 12, wherein the system for generating a target process flow further includes a system for determining, for each source element, a mapping of the source element to at least one target element in the second model format.

16. The system of claim 12, wherein the system for generating a target process flow further includes a system for processing each source element in the set of source elements that maps to a single target element in the second model format that includes a system for generating the single target element in the target process flow.

17. The system of claim 12, wherein the system for generating a target process flow further includes a system for processing a plurality of source elements in the set of source elements that map to a single target element in the target process flow that includes:
a system for generating the single target element in the target process flow; and
a system for generating at least one holder element in the target process flow.

18. The system of claim 12, further comprising a system for storing the target process flow in a storage object.

19. The system of claim 12, further comprising a system for receiving a transform request for the source process flow.

20. The system of claim 12, further comprising:
a system for receiving a target process modeling tool; and
a system for determining the second model format based on the target process modeling tool.

21. A process modeling tool that includes:
a system for managing an editor that enables a user to manage process flows;
a system for receiving a transform request for a source process flow in a first model format, wherein the source process flow includes a set of source elements; and
a system for generating a target process flow in a second model format based on the source process flow, wherein the system for generating includes a system for processing each source element in the set of source elements that maps to a plurality of target elements in the second model format that includes:
a system for applying a semantics mapping of the source element to the plurality of target elements;
a system for abstracting the plurality of target elements in a container element; and
a system for adding the container element with the plurality of target elements to the target process flow.

22. The process modeling tool of claim 21, further comprising a system for generating the transform request based on an import request for the source process flow.

23. The process modeling tool of claim 21, further comprising a system for generating the transform request based on an export request for the source process flow.

24. A program product stored on a computer-readable medium, which when executed, transforms a process flow, the program product comprising:
program code for obtaining a source process flow in a first model format, wherein the source process flow includes a set of source elements; and
program code for generating a target process flow in a second model format based on the source process flow, wherein the program code for generating includes program code for processing each source element in the set of source elements that maps to a plurality of target elements in the second model format that includes:
program code for applying a semantics mapping of the source element to the plurality of target elements;
program code for abstracting the plurality of target elements in a container element; and
program code for adding the container element with the plurality of target elements to the target process flow.

25. A method of offering a service to a customer of transforming a process flow, the method comprising:
managing a computer infrastructure adapted to perform each of the method steps of claim 1; and
receiving payment based on the managing step.
